(19) United States
(12) Patent Application Publication
(10) Pub. No.: US 2009/0169887 A1
(43) Pub. Date: Jul. 2, 2009

(54) Method for Producing Fine-Particle C.I. Pigment Red 254

(76) Inventors: Tanja Reipen, Mainz (DE); Carsten Plueg, Muehltal / Niederbeerbach (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/083,893

(22) PCT Filed: Sep. 12, 2006
(86) PCT No.: PCT/EP2006/008867

§ 371 Date: Apr. 18, 2008

(30) Foreign Application Priority Data
Oct. 21, 2005 (DE) 10 2005 050 511.2

(51) Int. Cl. B32B 1/00; B02C 17/00

(52) U.S. Cl. 428/402; 241/15; 241/27

(57) ABSTRACT

A process for preparing C.I. Pigment Red 254 having an average particle size (d₅₀) of 10 to 120 nm, and a half-width of the peak at 28.3° 2Theta of between 0.2 to 0.7° 2Theta in the X-ray powder diffractogram obtained using CU-Kₐₗₚₕₐ radiation, includes milling of a crystalline raw product of C.I. Pigment Red 254 in a liquid medium under the action of a grinding medium, in a ball-mill agitator, which is operated with a power density of more than 1.0 kW per litre grinding chamber and an agitator peripheral speed of more than 12 m/s.

The present invention is described in the German priority application No. 102005050511.2, filed Oct. 21, 2005, which is hereby incorporated by reference as is fully disclosed herein.

The present invention relates to a new process for preparing finely divided C.I. Pigment Red 254 by means of a stirred ball mill.

For the production of durable colorations of high transparency there is a need for particularly finely divided organic color pigments in order largely to rule out particle scattering. As compared with dyeings likewise of high transparency, the light fastness of pigments is significantly better.

As well as the conventional cyan-magenta-yellow color combination known from printing processes, the trichromatic system of red-green-blue (RGB) is becoming increasingly established in new fields such as that of color filters. Through the respective combination of each of the three base hues an attempt is made to depict a color space which is as large as possible. The respective base hues in this context can be generated through the use of individual pigments or the combinations of different pigments, or even by combination of pigments with dyes. Red base hues are increasingly being produced using finely divided C.I. Pigment Red 254 (I)

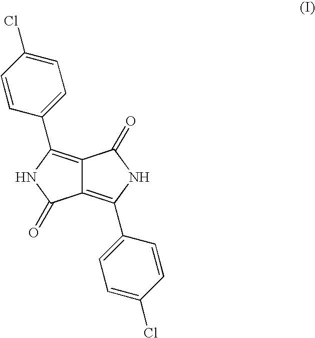

alone or in combination with other colorants, since it combines a clean hue with good transparency and with good fastness properties.

WO 01/04215 discloses a particularly finely divided C.I. Pigment Red 254 which is characterized by a particularly narrow particle size distribution in conjunction with high crystallinity and specific absorption characteristics. A C.I. Pigment Red 254 of this kind can be obtained by first subjecting a crude pigment to dry stirring with an inorganic salt at not less than 80° C., to convert it into a substantially amorphous form, and then to a kneading operation with inorganic salts in the presence of organic solvents.

The production operation described for this highly transparent pigment, however, is associated with disadvantages. As a result of the kneading operation, large quantities of salt and high-boiling solvent are obtained, which surpass by far the amount of pigment obtained and which have to be disposed of or recovered, which is a technically costly and inconvenient operation. The entire production process for the finely divided powder pigment therefore encompasses the operating steps of preliminary grinding to the amorphous state, salt kneading, pasting in water, filtering, washing until salt-free, and drying, and is therefore very costly and inconvenient. Furthermore, the crude pigment for grinding can be employed only in dry form, which implies an additional workstep after the synthesis of the material. C.I. Pigment Red 254 is typically recovered after synthesis in the form of water-moist filtercakes.

The problem which existed, therefore, was to provide a process for finely divided C.I. Pigment Red 254, having in particular the properties described in WO 01/04215, that overcomes the stated disadvantages and is able to start from a crude pigment in the form of a water-moist filtercake.

It has been found that the grinding of C.I. Pigment Red 254 in a stirred ball mill, surprisingly, solves this problem, although with this method at no point in time does the pigment pass through the stage of an amorphous form, which according to WO 01/04215 would have been absolutely necessary.

The process of the invention allows the purposive attainment of a state of fine division in the range 0.01 to 0.12 μm (d50) without losing the necessary crystallinity. The crystallinity is characterized by a half peak height of less than 0.7° 2theta for the largest peak (at 28.3° 2theta) in the X-ray powder diffractogram (CuK_{α} radiation). The line positions in the X-ray powder diffractogram typically carry an inaccuracy of +/−0.2°.

The invention provides a process for preparing C.I. Pigment Red 254 having an average particle size (d₅₀) of 10 to 120 nm, preferably 20 to 100 nm, and a 2theta value at half peak height for the peak at 28.3° of 0.2 to 0.7° 2theta, in particular of 0.3 to 0.66° 2theta, in the X-ray powder diffractogram with Cu—Kₐₗₚₕₐ radiation, which comprises grinding a crude crystalline product of C.I. Pigment Red 254 in a stirred ball mill, which is operated with a power density of more than 1.0 kW, in particular of more than 1.5 kW, per liter of grinding space and a peripheral stirrer speed of more than 12 m/s, in a liquid medium under the action of grinding media, preferably with a diameter less than or equal to 0.9 mm.

The stirred ball mill of the invention is designed for batch or continuous operation, with a cylindrical or hollow-cylindrical grinding space, in horizontal or vertical construction. Mills suitable for this purpose are described for example in DE-C-3 716 587. The energy emitted by the stirrer per unit time is transferred as comminution work and as frictional energy in the form of heat to the millbase. In order to remove this large quantity of heat without problem, it is necessary to take constructional measures to minimize the ratio of milling space to milling-space surface (cooling surface). At high throughputs milling takes place in circulation, and the heat is taken off to the outside predominantly via the millbase. Grinding media used include balls of zirconium oxide, zirconium mixed oxide, aluminum oxide or quartz. Preferred diameters are less than or equal to 0.9 mm; it is appropriate to use those with a diameter of 0.2 to 0.9 mm, preferably 0.3 to 0.5 mm. There are mills, however, which can be operated with grinding media having a size of 30-50 μm and which provide the required energy input.

When continuous stirred ball mills are used for fine division, the grinding media are separated from the millbase preferably by means of centrifugal deposition, so that the separation apparatus does not in practice come into contact with the grinding media, as a result of which instances of clogging of said apparatus are largely prevented. The stirred ball mills are operated with a high grinding charge. In this case of the continuous stirred ball mills, the grinding space is filled almost completely with grinding media.

The duration of grinding is dependent on the desired fineness of the C.I. Pigment Red 254. Therefore the residence time of the millbase in the stirred ball mill is generally between 3 and 60 minutes, preferably between 4 and 45 minutes, more preferably between 5 to 30 minutes.

Grinding is carried out advantageously at temperatures in the range from 0 to 100° C., preferably at a temperature between 10 and 60° C., more preferably at 20 to 50° C.

The liquid medium in the process of the invention is appropriately water. An alternative option is to use an aqueous organic medium. Suitable organic solvents include alcohols having 1 to 10 carbon atoms, such as methanol, ethanol, n-propanol, isopropanol, butanols, such as n-butanol, isobutanol, tert-butanol, pentanols, such as n-pentanol, 2-methyl-2-butanol, hexanols, such as 2-methyl-2-pentanol, 3-methyl-3-pentanol, 2-methyl-2-hexanol, 3-ethyl-3-pentanol, octanol, such as 2,4,4-trimethyl-2-pentanol, cyclohexanol; or glycols, such as ethylene glycol, diethylene glycol, propylene glycol, dipropylene glycol, or glycerol; polyglycols, such as polyethylene glycols or polypropylene glycols; ethers, such as methyl isobutyl ether, tetrahydrofuran, dimethoxyethane or dioxane; glycol ethers, such as monomethyl or monoethyl ethers of ethylene glycol or propylene glycol, diethylene glycol monomethyl ether, diethylene glycol monoethyl ether, butyl glycols or methoxybutanol; ketones, such as acetone, diethyl ketone, methyl isobutyl ketone, methyl ethyl ketone or cyclohexanone; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valerolactam or caprolactam; esters, such as carboxylic acid C₁-C₆ alkyl esters, such as butyl formate, ethyl acetate or propyl propionate; or carboxylic acid C₁-C₆ glycol esters; or glycol ether acetates, such as 1-methoxy-2-propyl acetate; or phthalic or benzoic acid C₁-C₆ alkyl esters, such as ethyl benzoate; cyclic esters, such as caprolactone; nitriles, such as acetonitrile or benzonitrile; aliphatic or aromatic hydrocarbons, such as cyclohexane or benzene; or alkyl-, alkoxy-, nitro- or halogen-substituted benzene, such as toluene, xylenes, ethylbenzene, anisole, nitrobenzene, chlorobenzene, o-dichlorobenzene, 1,2,4-trichlorobenzene or bromobenzene; or other substituted aromatics, such as benzoic acid or phenol; aromatic heterocycles, such as morpholine, picoline or quinoline; and also hexamethylphosphoramide, 1,3-dimethyl-2-imidazolidinone, dimethyl sulfoxide and sulfolane.

Particular preference is given to water and to mixtures of C₁-C₆ alcohols, N-methylpyrrolidone and/or glycols with water.

After the end of the grinding the pigments are typically isolated by filtration. Prior to isolation of a pigment it is possible for any solvent employed to be removed by distillation, where appropriate under reduced pressure, or else by steam distillation.

The crude pigment employed is crystalline in nature, preferably characterized by a 2theta value at half peak height, for the largest peak at 28.3°, of 0.1 to 0.5° 2theta, in particular of 0.2 to 0.4° 2theta, in the X-ray powder diffractogram of Cu—Kₐₗₚₕₐ radiation, and by an average particle size of 150 to 1000 nm, preferably 200 to 500 nm. It can be prepared for example in accordance with U.S. Pat. No. 4,579,949 and can be employed in pulverulent form or, preferably, in the form of water-moist filtercakes or moist granules.

The suspension obtained in the course of grinding in accordance with the invention may be subjected as it is or after filtration, as a filtercake or dried material, if desired, to a solvent aftertreatment, in order to obtain a more homogeneous particle morphology without markedly increasing the particle size. Preference is given to using water or steam-volatile solvents such as alcohols and aromatic solvents, more preferably branched or unbranched C₁-C₆ alcohols, toluene, xylene, chlorobenzene, dichlorobenzene, nitrotoluene or nitrobenzene, usually at elevated temperature, up to 200° C. for example, and under elevated pressure if appropriate.

A moist pigment can be dried using the known drying assemblies, such as drying ovens, bucket-wheel dryers, tumble dryers, contact dryers, and, in particular, spin flash dryers and spray dryers.

The pigment obtained by the process of the invention may comprise further, customary auxiliaries or additives, such as, for example, surfactants, nonpigmentary or pigmentary dispersants, fillers, standardizers, resins, waxes, defoamers, antidust agents, extenders, antistatics, preservatives, drying retardants, wetting agents, antioxidants, UV absorbers, and light stabilizers, preferably in an amount of 0.1% to 10% by weight, in particular 0.5% to 5% by weight, based on the total weight of the pigment.

Suitable surfactants include anionic, or anion-active, cationic, or cation-active, and nonionic or amphoteric substances, or mixtures of these agents.

Examples of suitable anionic substances include fatty acid taurides, fatty acid N-methyltaurides, fatty acid isethionates, alkylphenylsulfonates, an example being dodecylbenzenesulfonic acid, alkylnaphthalenesulfonates, alkylphenol polyglycol ether sulfates, fatty alcohol polyglycol ether sulfates, fatty acid amide polyglycol ether sulfates, alkylsulfosuccinamates, alkenylsuccinic monoesters, fatty alcohol polyglycol ether sulfosuccinates, alkanesulfonates, fatty acid glutamates, alkylsulfosuccinates, fatty acid sarcosides; fatty acids, examples being palmitic, stearic and oleic acid; the salts of these anionic substances and soaps, examples being alkali metal salts of fatty acids, naphthenic acids and resin acids, abietic acid for example, alkali-soluble resins, rosin-modified maleate resins for example, and condensation products based on cyanuric chloride, taurine, N,N′-diethylaminopropylamine and p-phenylenediamine. Preference is given to resin soaps, i.e., alkali metal salts of resin acids.

Examples of suitable cationic substances include quaternary ammonium salts, fatty amine oxalkylates, polyoxyalkyleneamines, oxalkylated polyamines, fatty amine polyglycol ethers, primary, secondary or tertiary amines, examples being alkylamines, cycloalkylamines or cyclized alkylamines, especially fatty amines, diamines and polyamines derived from fatty amines or fatty alcohols, and the oxalkylates of said amines, imidazolines derived from fatty acids, polyaminoamido or polyamino compounds or resins having an amine index of between 100 and 800 mg of KOH per g of the polyaminoamido or polyamino compound, and salts of these cationic substances, such as acetates or chlorides, for example.

Examples of suitable nonionic and amphoteric substances include fatty amine carboxyglycinates, amine oxides, fatty alcohol polyglycol ethers, fatty acid polyglycol esters, betaines, such as fatty acid amide N-propyl betaines, phosphoric esters of aliphatic and aromatic alcohols, fatty alcohols or fatty alcohol polyglycol ethers, fatty acid amide ethoxylates, fatty alcohol-alkylene oxide adducts and alkylphenol polyglycol ethers.

By nonpigmentary dispersants are meant substances which structurally are not derived from organic pigments. They are added as dispersants either during the actual preparation of pigments, but often, also, during the incorporation of the pigments into the application media that are to be colored: for example, during the preparation of color filters, by dispersing the pigments into the corresponding binders. They may be polymeric substances, examples being polyolefins, polyesters, polyethers, polyamides, polyimines, polyacrylates, polyisocyanates, block copolymers thereof, copolymers of the corresponding monomers, or polymers of one class modified with a few monomers from a different class. These polymeric substances carry polar anchor groups such as, for example, hydroxyl, amino, imino and ammonium groups, carboxylic acid and carboxylate groups, sulfonic acid and sulfonate groups or phosphonic acid and phosphonate groups, and may also have been modified with aromatic, nonpigmentary substances. Dispersants may additionally also be aromatic substances modified chemically with functional groups. Dispersants of this kind are known to the skilled worker and in some cases are available commercially (e.g., Solsperse®, Avecia; Disperbyk®, Byk-Chemie; Efka®, Efka). A number of types will be named below, by way of representation, although in principle any desired other substances described can be employed, examples being condensation products of isocyanates and alcohols, diols or polyols, amino alcohols or diamines or polyamines, polymers of hydroxycarboxylic acids, copolymers of olefin monomers or vinyl monomers and ethylenically unsaturated carboxylic acids and carboxylic esters, urethane-containing polymers of ethylenically unsaturated monomers, urethane-modified polyesters, condensation products based on cyanuric halides, polymers containing nitroxyl compounds, polyester amides, modified polyamides, modified acrylic polymers, dispersants with a comblike structure comprising polyesters and acrylic polymers, phosphoric esters, triazine-derived polymers, modified polyethers, or dispersants derived from aromatic substances. These parent structures are in many cases modified further, by means for example of chemical reaction with further substances carrying functional groups, or by means of salt formation.

By pigmentary dispersants are meant pigment dispersants which derive from an organic pigment parent structure and are prepared by chemically modifying said parent structure, examples being saccharine-containing pigment dispersants, piperidyl-containing pigment dispersants, naphthalene- or perylene-derived pigment dispersants, pigment dispersants having functional groups which are attached to the pigment parent structure via a methylene group, pigment parent structures chemically modified with polymers, pigment dispersants containing sulfo acid, sulfonamide or sulfo acid ester groups, pigment dispersants containing ether or thioether groups, or pigment dispersants containing carboxylic acid, carboxylic ester or carboxamide groups.

Anionic groups of the nonpigmentary and pigmentary dispersants, surfactants or resins used as auxiliaries may also be laked, using for example Ca, Mg, Ba, Sr, Mn or Al ions or using quaternary ammonium ions.

By fillers and/or extenders are meant a multiplicity of substances in accordance with DIN 55943 and DIN EN 971-1, examples being the various types of talc, kaolin, mica, dolomite, lime, barium sulfate or titanium dioxide. In this context it has proven particularly appropriate to make the addition before the pulverization of the dried pigment preparation.

By value at half peak height is meant the width value of a reflection at half peak height (half of the maximum).

The half peak height values of the samples are measured using a STOE/θ-diffractometer (Cu—K_{α}, U=40 kV, I=40 mA) (slits: primary side/vertical 2×8 mm, primary side/horizontal 1.0 mm, secondary side 0.5 mm). The sample holder used is a standard steel holder. The measurement time is tailored to the desired statistical reliability; the 2θ angle range in the overview measurement is 5-30° and the step width is 0.02° with a time period of 3 s. In the special range, measurement is carried out from 23-30° with a step width of 0.02° and a time period of 6 s.

The X-ray beam is monochromated by a graphite secondary monochromator and measured with a scintillation counter with continuous sample rotation. For the purpose of evaluation a profile fit is carried out over the entire angle range of the second measurement, 2θ=23-30°(fit function: Lorentz² (4 reflections)).

For the particle size distribution a series of electromicrographs is used. The primary particle sizes are identified visually. The area of each primary particle is determined used a graphics tablet. The area is used to determine the diameter of the circle of equal area. The frequency distribution of the equivalent diameters calculated in this way is determined, and the frequencies are converted into volume fractions and expressed as the particle size distribution.

### EXAMPLE 1

A mixture of 10 g of P.R. 254, prepared according to example 6 of U.S. Pat. No. 4,579,949, with an average particle size of 250 nm and a 2theta (CuK_{α}) value at half peak height, for the main peak at 28.3°, of 0.233° 2theta, 360 g of zirconium mixed oxide beads (0.3-0.4 mm) and 90 g of water is ground for 15 minutes in a Drais® PML mill with a peripheral stirrer speed of 15.6 m/s and a specific power density of 3.1 kW per liter of milling space. The millbase is separated from the beads, filtered, dried under reduced pressure and, finally, pulverized. The resulting product has a 2theta (CuK_{α}) value at half peak height, for the main peak at 28.3°, of 0.538° 2theta, a d₅₀ value of about 60 nm, and a coarse fraction (particles greater than 100 nm) of less than 5%.

### EXAMPLE 2

A mixture of 10 g of P.R. 254, prepared according to example 6 of U.S. Pat. No. 4,579,949, with an average particle size of 250 nm and a 2theta (CuK_{α}) value at half peak height, for the main peak at 28.3°, of 0.233° 2theta, 360 g of zirconium mixed oxide beads (0.3-0.4 mm) and 90 g of water is ground for 30 minutes in a Drais® PML mill with a peripheral stirrer speed of 15.6 m/s and a specific power density of 3.1 kW per liter of milling space. The millbase is separated from the beads, filtered, dried under reduced pressure and, finally, pulverized. The resulting product has a 2theta (CuK_{α}) value at half peak height, for the main peak at 28.3°, of 0.630° 2theta, a d₅₀ value of about 60 nm, and a coarse fraction (particles greater than 100 nm) of less than 5%.

### EXAMPLE 3

A mixture of 10 g of P.R. 254, prepared according to example 6 of U.S. Pat. No. 4,579,949, with an average particle size of 250 nm and a 2theta (CuK_{α}) value at half peak height, for the main peak at 28.3°, of 0.233° 2theta, 360 g of zirconium mixed oxide beads (0.3-0.4 mm) and 90 g of water is ground for 45 minutes in a Drais® PML mill with a peripheral stirrer speed of 15.6 m/s and a specific power density of 3.1 kW per liter of milling space. The millbase is separated from the beads, filtered, dried under reduced pressure and, finally, pulverized. The resulting product has a 2theta (CuK_{α}) value at half peak height, for the main peak at 28.3°, of 0.652° 2theta, a d₅₀ value of about 60 nm, and a coarse fraction (particles greater than 100 nm) of less than 5%.

### EXAMPLE 4

A mixture of 2564 g of a water-moist, 39% by weight filtercake of C.I. Pigment Red 254, prepared according to example 6 of U.S. Pat. No. 4,579,949, with an average particle size of 250 nm and a 2theta (CuK_{α}) value at half peak height, for the main peak at 28.3°, of 0.233° 2theta and 100 g of a commercially customary, naphthalenesulfonic acid-based flow improver is converted to a homogeneous paste and ground using a Drais® Super Flow mill in the presence of 2190 g of zirconium dioxide beads (0.3-0.4 mm) with a peripheral stirrer speed of 13.3 m/s and a specific power density of 5.5 kW (1.2 liter milling space), the pigment concentration being set at 10% by weight by addition of water. The duration of grinding corresponds to two to three theoretical grinding passes. The ground suspension is admixed with isobutanol, forming a 1:1 mixture of isobutanol and water. The suspension is heated at reflux for 2 hours at a pH of 7 in the presence of a phosphate buffer; after the isobutanol has been separated off by steam distillation the suspension is filtered and the solid product is washed phosphate-free with water, dried under reduced pressure and, finally, pulverized. This gives 800 g of a pigment having an average particle size of 100 nm (TEM), the fraction of particles greater than 150 nm being below 5%. The product has a 2theta (CuK_{α}) value at half peak height, for the main peak at 28.3°, of 0.342° 2theta.

### EXAMPLE 5

A mixture of 911 g of a water-moist, 44% by weight filtercake of C.I. Pigment Red 254, prepared according to example 6 of U.S. Pat. No. 4,579,949, with an average particle size of 250 nm and a 2theta (CuK_{α}) value at half peak height, for the main peak at 28.3°, of 0.233° 2theta, 12 g of a commercially customary, naphthalenesulfonic acid-based flow improver, and 40 g of a pigment dispersant of the formula (II)

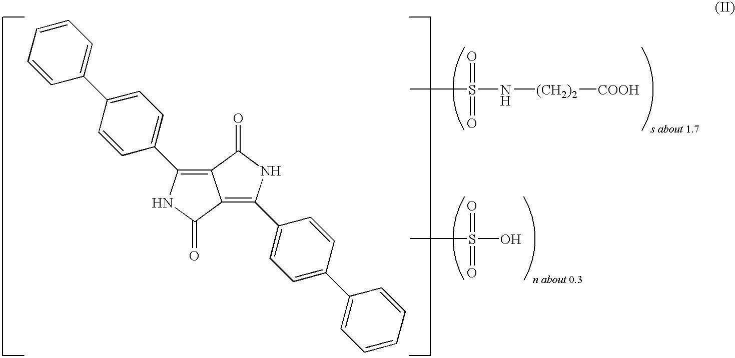

prepared in accordance with example 1a from EP 1 362 081 is converted to a homogeneous paste in a dissolver (900 rpm) and then ground using a Drais® Super Flow mill in the presence of 2190 g of zirconium dioxide beads (0.3-0.4 mm) with a peripheral stirrer speed of 13.3 m/s and a specific power density of 5.5 kW (1.2 liter milling space), the pigment concentration being set at 10% by weight by addition of water. The duration of grinding corresponds to two to three theoretical grinding passes. The ground suspension is admixed with isobutanol, forming a 1:1 mixture of isobutanol and water. The suspension is acidified to a pH of 2 using phosphoric acid and heated at reflux for 2 hours, after the isobutanol has been separated off by steam distillation filtered. The filter cake is washed with water, dried under reduced pressure and, finally, pulverized. This gives 350 g of a pigment having an average particle size of 37 nm (TEM), the fraction of particles greater than 73 nm being below 5%. The product has a 2theta (CuK_{α}) value at half peak height at 28.3°, of 0.431° 2theta.

### EXAMPLE 6

A mixture of 995 g of a water-moist, 40% by weight filtercake of C.I. Pigment Red 254, prepared according to example 6 of U.S. Pat. No. 4,579,949, with an average particle size of 250 nm and a 2theta (CuK_{α}) value at half peak height, for the main peak at 28.3°, of 0.233° 2theta, 32 g of the 25% solution of a sodium salt of a commercially customary styrene acrylate resin (M>15 000) in water, and 20 g of a pigment dispersant of the formula (II), prepared in accordance with example 1a from EP 1 362 081 is converted to a homogeneous paste in a dissolver (900 rpm) and then ground using a Drais® Super Flow mill in the presence of 2190 g of zirconium dioxide beads (0.3-0.4 mm) with a peripheral stirrer speed of 13.3 m/s and a specific power density of 5.5 kW (1.2 liter milling space), the pigment concentration being set at 10% by weight by addition of water. The duration of grinding corresponds to two to three theoretical grinding passes. The ground suspension is admixed with isobutanol, forming a 1:1 mixture of isobutanol and water. The suspension is acidified to a pH of 2 using phosphoric acid and heated at reflux for 2 hours, after the isobutanol has been separated off by steam distillation filtered. The filter cake is washed with water, dried under reduced pressure and, finally, pulverized. This gives 348 g of a pigment having an average particle size of 36 nm (TEM), the fraction of particles greater than 79 nm being below 5%. The product has a 2theta (CuK_{α}) value at half peak height at 28.3°, of 0.485° 2theta.

### APPLICATION EXAMPLES

### Color Filters

7.2 g of ®Joncryl 611 (styrene-acrylate resin, Johnson Polymers) are stirred in 13.4 g of PGMEA for one hour and admixed with stirring with a further 42 g of PGMEA,
7.2 g of pigment, 1.8 g of ®Solsperse 24 000 and 0.36 g of Solsperse 22 000 (Avecia). Following the addition of 122 g of zirconium oxide beads (0.5-0.7 mm), the batch is dispersed in a Paint Shaker for two hours. The pigment dispersion is applied with the aid of a spin coater (POLOS wafer spinner) to glass plates (SCHOTT, laser-cut, 10×10 cm) and the contrast is measured (goniometer DMS 803, spectrograph CCD-SPECT2).

The pigments from examples 1-6 are highly suitable for color filter applications, owing to their high contrast.

1) A process for preparing C.I. Pigment Red 254 having an average particle size d₅₀ of 10 to 120 nm and a 2theta value at half peak height for the peak at 28.3° of 0.2 to 0.7° 2theta in the X-ray powder diffractogram with Cu—Kₐₗₚₕₐ radiation, comprising the step of grinding a crude crystalline product of C.I. Pigment Red 254 in a stirred ball mill, wherein the ball mill is operated with a power density of more than 1.0 kW per liter of grinding space and a peripheral stirrer speed of more than 12 m/s, in a liquid medium under the action of grinding media.

2) The process as claimed in claim 1, wherein the crude crystalline product has a 2theta value at half peak height for the peak at 28.3° of 0.1 to 0.5° 2theta in the X-ray powder diffractogram of Cu—Kₐₗₚₕₐ radiation.

3) The process as claimed in claim 1, wherein the crude crystalline product has an average particle size of 150 to 1000 nm.

4) The process as claimed in claim 1, wherein the liquid medium is water or an aqueous organic medium.

5) The process as claimed in claim 1, wherein the liquid medium is water or a mixture of water and one or more of C₁-C₆ alcohols, glycols, or N-methylpyrrolidone.

6) The process as claimed in claim 1, wherein the stirred ball mill is operated with a power density of more than 1.5 kW per liter of grinding space.

7) The process as claimed in claim 1, wherein grinding media used are balls of zirconium oxide, zirconium mixed oxide, aluminum oxide or quartz.

8) The process as claimed in claim 1, wherein the residence time of the crude crystalline product of C.I. Pigment Red 254 in the stirred ball mill is between 3 and 60 minutes.

9) The process as claimed in claim 1, wherein the grinding is carried out at a temperature in the range from 0 to 100° C.

10) The process as claimed in claim 1, wherein the crude crystalline product is employed in the form of water-moist filtercakes or in the form of moist granules.

11) C.I. Pigment Red 254 having an average particle size d₅₀ of 10 to 120 nm and a 2theta value at half peak height for the peak at 28.3° of 0.2 to 0.7° 2theta in the X-ray powder diffractogram with Cu—Kₐₗₚₕₐ radiation made in accordance with the process of claim 1.
